(19) United States
(12) Patent Application Publication
(10) Pub. No.: US 2007/0203714 A1
(43) Pub. Date: Aug. 30, 2007

(54) Purchasable Token Bandwidth Portioning

(75) Inventors: Elizabeth Rose McEnroe, Palo Alto, CA (US); Thomas H. Taylor, Redmond, WA (US); Mark Wagner, Seattle, WA (US); Peter J. Potrebic, Calistoga, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/276,445

(22) Filed: Feb. 28, 2006

(51) Int. Cl. G06Q 10/00; G06Q 30/00

(52) U.S. Cl. 705/1; 705/35

(57) ABSTRACT

Embodiments of purchasable token bandwidth portioning techniques are described herein. Tokens are designated to portion bandwidth, allocated by a content provider to stream contents, to a plurality of client devices as a group. When one of the client devices attempts to consume content that would cause the group to exceed the allocated amount of bandwidth, an additional token is purchased.

### BACKGROUND

Traditionally, in order to receive television programs, users were limited to broadcasts of the television programs that were received via antennas, from cable providers, and so on. For example, the user may have configured a traditional “over-the-air” antenna, connected a cable to a television set, and so on to receive broadcasts of television programs.

Today, however, users are consistently exposed to ever greater varieties and amounts of content. For example, users may now receive and interact with pay-per-view (PPV) content (e.g., movies and sporting events), video-on-demand (VOD), video games, and so on. Additionally, users are continually be exposed to content having an ever increasing “richness”, such as that experienced in a transition from standard-definition content to enhanced-definition content to high-definition content, and so on.

Providing this content to the users, however, may consume a significant amount of bandwidth. For example, a content provider may provide multiple streams of content to hundreds and thousands of locations, e.g., households. Therefore, to ensure that each household may receive content as desired, the content provider may allocate portions of the content to each household. However, each household may be able to consume more content than that which is allocated, which may lead to user frustration when not properly managed, thereby adversely affecting the user's experience with this content.

### SUMMARY

Purchasable token bandwidth portioning techniques are described. Tokens are designated to portion bandwidth, allocated by a content provider to stream content, to a plurality of client devices as a group. When one of the client devices attempts to consume content that would cause the group to exceed the allocated amount of bandwidth, an additional token is purchased.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an environment in an exemplary implementation that is operable to employ purchasable token bandwidth portioning techniques.

FIG. 2 is an illustration of an exemplary implementation of a system showing allocation of content from a content provider by a viewing system of FIG. 1 in greater detail.

FIG. 3 is a flow diagram depicting a procedure in an exemplary implementation in which portions of bandwidth provided by a content provider have designated tokens which are used to manage consumption of the content in a viewing system.

FIG. 4 is a flow diagram depicting a procedure in an exemplary implementation in which different types of tokens are managed to consume content in a viewing system.

FIG. 5 is a flow diagram depicting a procedure in an exemplary implementation in which a token type is changed for a first client when a second client attempts to consume content that would cause bandwidth allocated to a viewing system to be exceeded.

FIG. 6 is a flow diagram depicting a procedure in an exemplary implementation in which purchasable token bandwidth portioning techniques are described.

FIG. 7 illustrates a user interface 700 in an exemplary implementation which may be employed in the procedure of FIG. 6.

FIG. 8 illustrates an exemplary implementation of a client device of FIGS. 1 and 2 in greater detail.

FIG. 9 illustrates a system in an exemplary implementation in which a content provider of FIGS. 1 and 2 is shown in greater detail.

The same reference numbers are utilized in instances in the discussion to reference like structures and components.

### DETAILED DESCRIPTION

Overview

Users are continually exposed to ever increasing amounts and varieties of content. Further, the “richness” of this content is ever increasing, such as by providing high-definition content in addition to standard-definition content, by providing surround-sound audio in addition to stereo-sound and “mono” audio, and so on. However, the bandwidth available to provide this content may be limited due to the amount of bandwidth consumed when communicating each of these rich varieties of content.

Therefore, a content provider may allocate a certain amount of bandwidth to each household to ensure that each household is able to consume content. One or more of the households, however, may have an ability to consume more bandwidth than that which is allocated to the household. For example, a household may have a number of client devices (e.g., televisions) that, as a whole, are able to consume more bandwidth (e.g., streams of content) than that which is allocated by the content provider.

Accordingly, token bandwidth portioning techniques may be employed to manage consumption of the content within a household, such as to ensure that the bandwidth allocated to the household if efficiently shared and is not exceeded. Therefore, the content provider may efficiently distribute content to each household and have that content managed within the household. For example, a token may be designated for each stream of content (e.g., a television channel having television programs) that is allocated for the household. When a client device (e.g., a set-top box) is assigned a token, that client device is authorized to consume content e.g., to render a television program for viewing, to record the television program for later viewing, and so on. Thus, household consumption of the streams of content (and more particularly consumption by the client devices within the household) may be managed by managing distribution of the tokens.

Management of content consumption within a location (e.g., the previously described household) may be performed in a variety of ways. For example, when a request is received to consume content beyond that which is allocated to a location, a determination may be made as to whether a predetermined condition has been met by another client device which is currently assigned a token to pass the token from the other client device to the requesting client device. The other client device, for instance, may be “idle” for at least a predetermined amount of time, e.g., has not received an input from a user. When the condition is met (e.g., the other client is idle), the token assigned to the other device may be passed to the client device which made the request. Thus, the tokens may be efficiently distributed to the client devices.

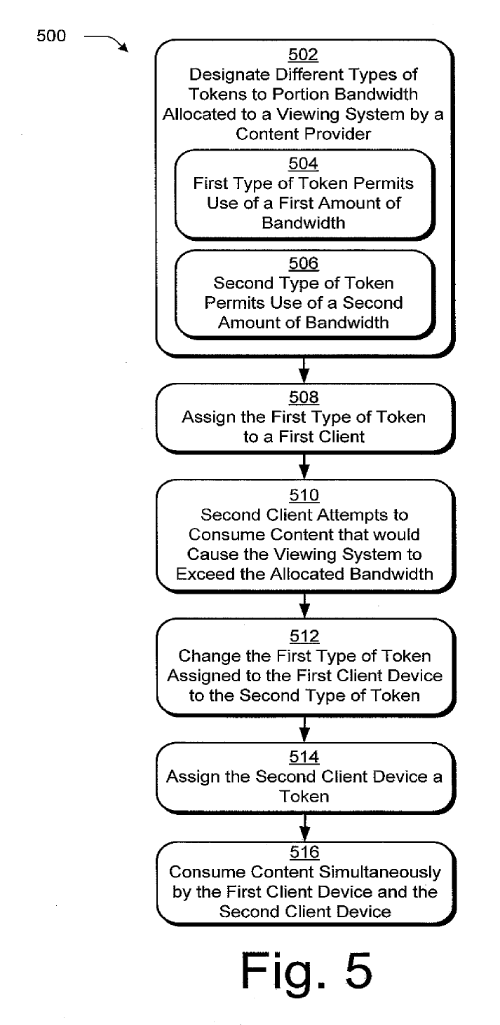

In another example, tokens may be changeable such that the allocated amount of bandwidth is not exceeded. For instance, different tokens may be designated to different amount of bandwidth, such as a high-definition (HD) token for consumption of HD content, a standard-definition (SD) token for consumption of SD content, a picture-in-picture token for consumption of PIP content, and so on. A first client may be assigned the HD token and consume SD content. When a second client attempts content consumption that would cause the viewing system to exceed the amount of bandwidth allocated to the viewing system, the HD token of the first client may be changed to an SD token (e.g., replaced with a SD token) to “free” bandwidth which is not being used by the first client. In this way, the second client may then also be assigned a SD token to consume content without interrupting the consumption of the content by the first client. Further discussion of changeable tokens may be found in relation to FIG. 5.

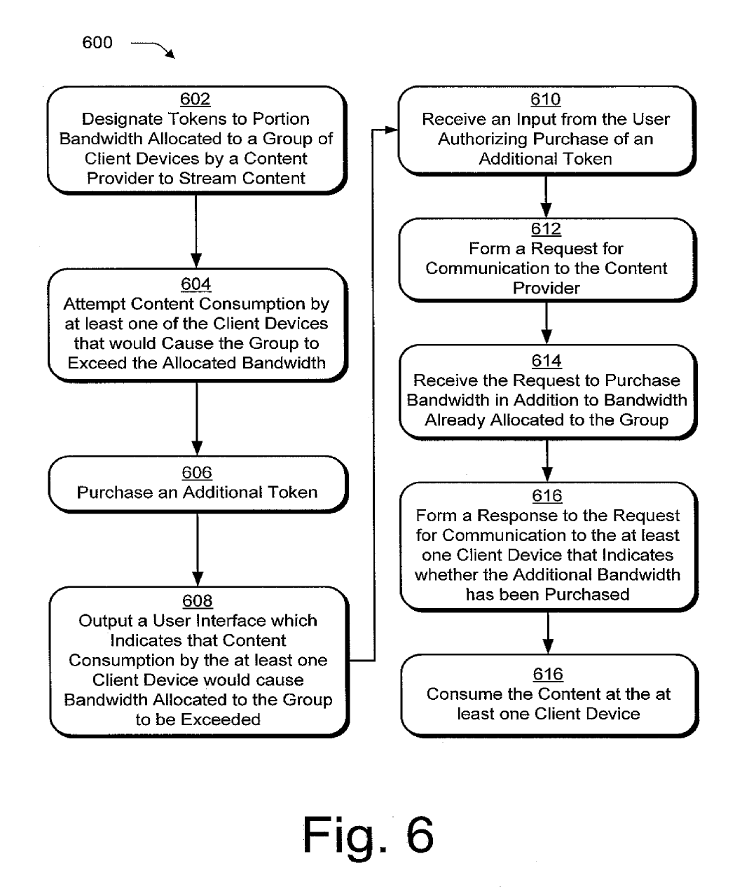

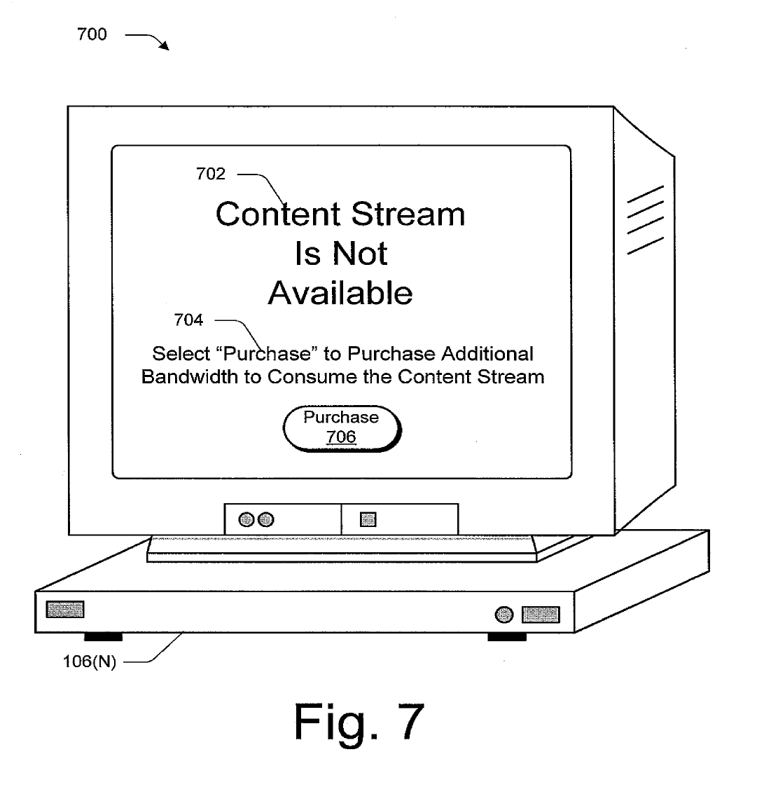

In yet another example, additional tokens may be purchased when the amount of bandwidth allocated to the viewing system is going to be exceeded. For example, one or more client devices in a viewing system may at one time consume bandwidth that is allocated to the viewing system. When another client device attempts content consumption (e.g., to purchase a VOD movie), that client device may be given an opportunity to purchase another token to consume (e.g., view) the content. Thus, the allocated bandwidth may be “expanded” when additional consumption is desired, further discussion of which may be found in relation to FIGS. 6-7.

In the following discussion, an exemplary environment is first described that is operable to employ token bandwidth portioning techniques. Exemplary procedures are then described which may be implemented by the exemplary environment, as well as in other environments. Exemplary systems are then described which may implement portions of the exemplary environment.

Exemplary Environment

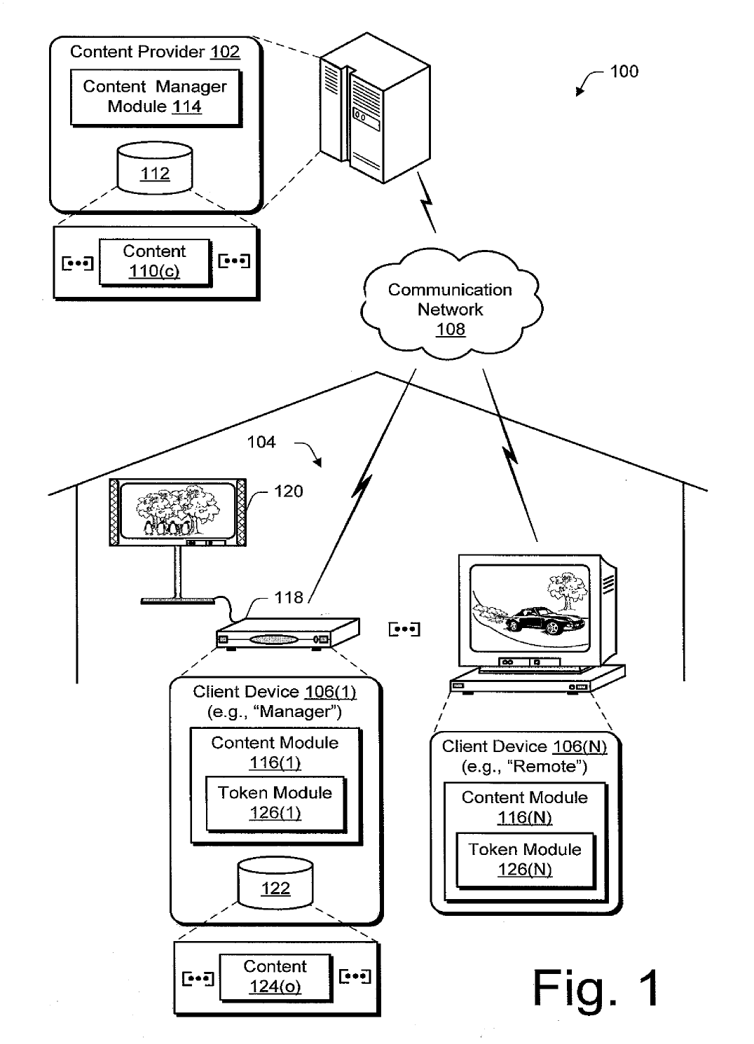

FIG. 1 illustrates an environment 100 in an exemplary implementation that is configured to employ token bandwidth portioning techniques. Although the environment 100 of FIG. 1 is illustrated as an IP-based television (IPTV) environment, the environment 100 may assume a wide variety of other configurations, such as a traditional television broadcast environment, a broadcast environment with back-channel communication capabilities, and so on.

The environment 100 includes a content provider 102 (which may be representative of multiple content providers) and a viewing system 104 that can include any number of client devices, which are illustrated as client devices 106(1)-106(N). The viewing system 104, thus, defines a “group” of client device 106(1)-106(N) and is illustrated as a household viewing system that has several viewing areas (e.g., different rooms) for viewing content, such as television programming. Although the viewing system 104 is depicted as employed within a particular premises (e.g., the household), it should be apparent that the viewing system 104 may also be employed in multiple premises without departing from the spirit and scope thereof.

The viewing system 104 is configured for communication with the content provider 102 via a communication network 108 which, in this example, is an IP-based network. The content provider 102 is illustrated as including a variety of content 110(c) (where “c” can be any integer from one to “C”) that is stored in storage 112, e.g., a computer-readable medium.

The content 110(c) may be configured for distribution over the communication network 108 (e.g., through execution of a content manager module 114) in a variety of ways. For example, the content 110(c) may include any form of television programs, commercials, music, movies, video on-demand (VOD), pay-per-view (PPV), movies and other media content, recorded media content, interactive games, network-based applications, and any other similar audio, video, and/or image content. In addition, content 110(c) in general may include music streamed from a computing device to one or more of the client devices 106(1)-106(N), such as a television-based set-top box, and may also include video-on-demand (VOD) media content delivered from a server, a photo slideshow, and any other audio, video, and/or image content received from any type of content source.

To control consumption of the content 110(c) received from over the communication network 108 (as well as content that is available locally), each of the client devices 106(1)-106(N) is illustrated as including a respective content module 116(1)-116(N). The content modules 116(1)-116(N) are executable to provide a wide variety of functionality related to content output. For example, the content modules 116(1)-116(N) may be executed to communicate with the content provider 102 (and more particularly the content manager module 114) to request particular content 110(c). For instance, the content module 116(1), when executed, may provide authentication and billing information to order VOD, PPV, and so on. In another example, the content modules 116(1)-116(N) are executable to decompress and decrypt content 110(c) received from the communication network 108 and provide other digital rights management functionality. A variety of other examples are also contemplated.

Client device 106(1), for instance, is illustrated as being implemented by a set-top box 118 that is communicatively coupled to a display device 120, such as any type of television, monitor, or similar television-based display system that renders audio, video, and/or image data. Client device 106(1) is also illustrated as including digital video recorder (DVR) functionality. For example, client device 106(1), through execution of the content module 116(1), may record content 110(c) received from the content provider 102 over the communication network 108 in storage 122 as content 124(o), where “o” can be any integer from one to “O”. Therefore, client device 106(1) may output the content 124(o) from storage 122 at a later time as desired by a user of the client device 106(1). Further, the client device 106(1) (e.g., through execution of the content module 116(1)) may provide other DVR related functionality, such as “time shifting” an output of the content 124(o), e.g., by pausing playback of content 124(o) through use of a pause buffer.

The viewing system 104 may also utilize a variety of other techniques to record content. For example, the storage 122 may be implemented as an independent component of the viewing system 104 and connected to the manager client device 106(1). Alternatively, the storage 122 may be implemented as a component of the manager client device 106(1) as illustrated, which manages recordings initiated from any of the other remote client devices 106(2)-106(N). In yet another embodiment, the storage 122 may be a distributed recording system where any one or more of the client devices 106(1)-106(N) include recording media that is centrally managed by the manager client device 106(1). In still yet another embodiment, the storage 122 may be implemented by the content provider 102 (e.g., when configured as a head end) and managed by the manager client device 106(1) as a “network digital video recorder” (NDVR). In other words, the storage 122 may also be provided as a “drive in the sky” that is responsive to one or more of the client devices 106(1)-106(N).

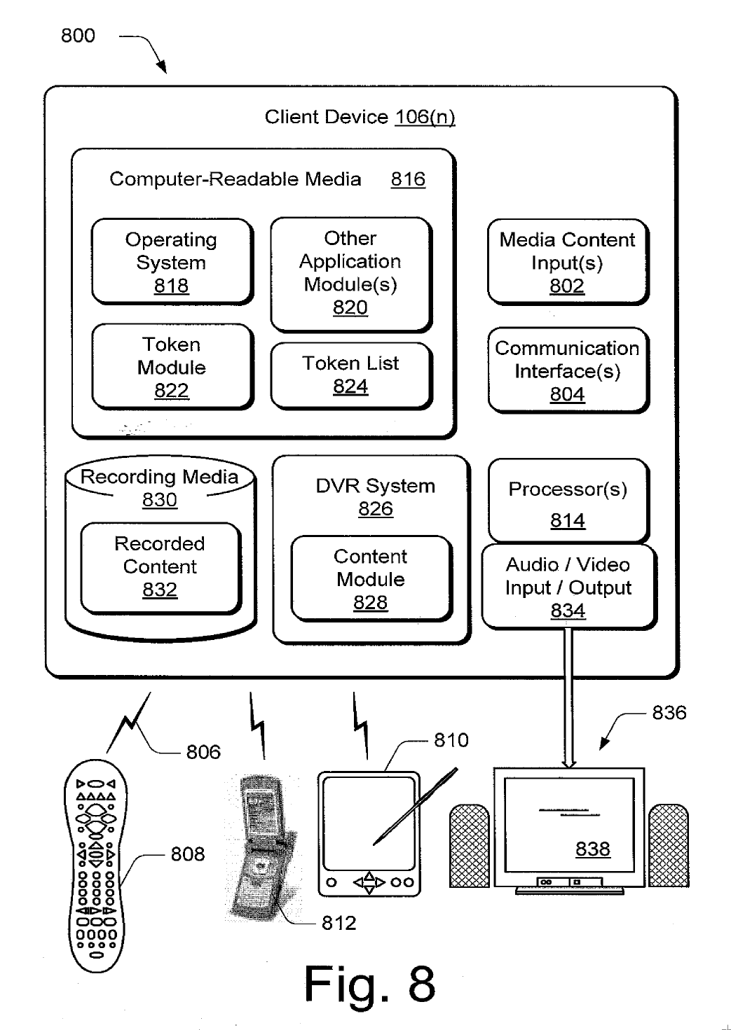

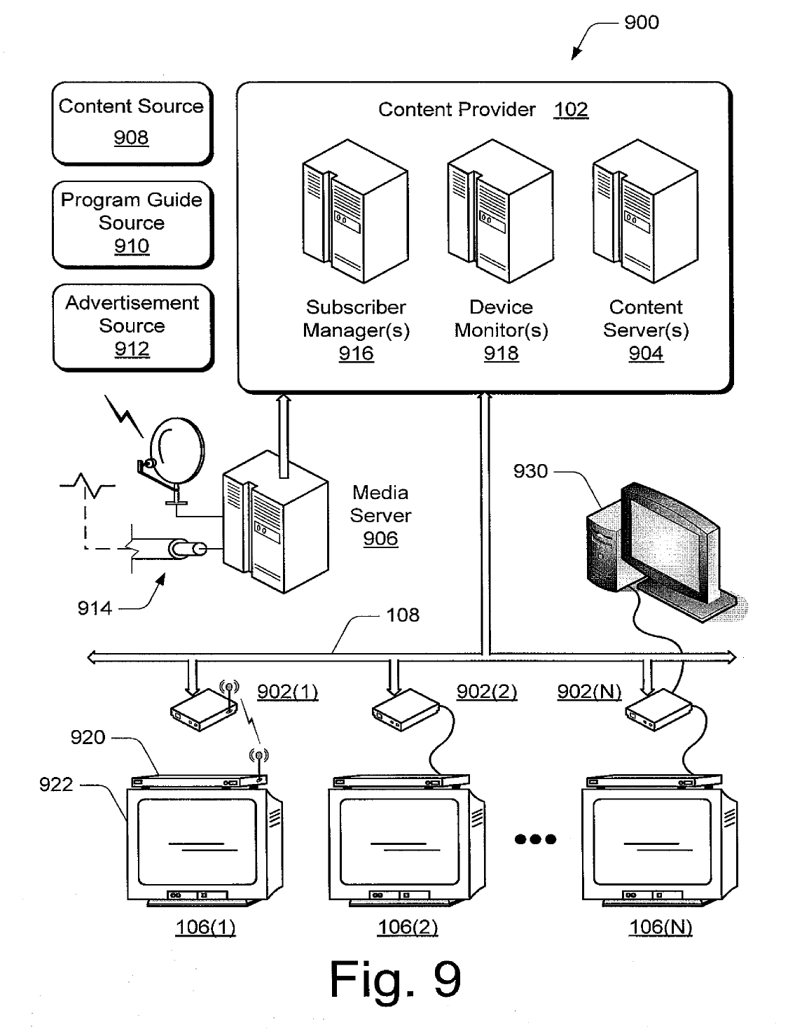

Although a few examples of client devices 106(1)-106(N) have been described, the client devices 106(1)-106(N) may also be configured in a wide variety of other ways, such as wireless phones, game consoles, “media centers”, and so on. For example, client device 106(N) is illustrated in FIG. 1 as a set-top box that does not include DVR functionality, unlike client device 106(1) of FIG. 1. Thus, the client devices 106(1)-106(N) may be implemented in a variety of different ways to provide different amounts of functionality (e.g., “thin” or “thick” devices) with any number and combination of differing components, an example of which is further described with reference to the exemplary client device 106(n) shown in FIG. 8. Likewise, the environment 100 may be implemented with any number and combination of differing components, an example of which is described below with reference to the exemplary entertainment and information system 900 shown in FIG. 9.

Content 110(c) may be allocated to the client devices 106(1)-106(N) by the content provider 102 in a variety of ways. For example, each of the premises (e.g., the illustrated household) may be allocated a certain amount of bandwidth by the content provider 102. The premises may then use one or more techniques to determine which clients 106(1)106(N) receive portions of the allocated bandwidth. In other words, the viewing system 104 (itself) may allocate which portion of the bandwidth allocated to viewing system 104 is provided to particular client devices 106(1)-106(N) within the viewing system 104.

In the exemplary viewing system 104, for instance, client device 106(1) is depicted as a “manager” client device that is responsible for allocating the streams, thereby managing distribution of the content streams to one or more of the other “remote” client devices, such as client device 106(N). Thus, the “manager” client device 106(1) manages content 110(c) consumption within the viewing system 104, which may be performed using a variety of techniques.

Each of the client devices 106(1)-106(N), for instance, may include a respective token module 126(1)-126(N) that is responsible for maintaining tokens that determine which of the client devices 106(1)-106(N) are authorized to receive content 110(c) from the content provider 102. The “remote” client device 106(N), for example, may connect to the manager client device 106(1) to receive a content stream for live television using a token. Additionally, the remote client device 106(N) may connect to the manager client device 106(1) to received content which does not require a token for consumption, such as delayed program viewing, and/or recorded DVR playback from content 124(o) stored in storage 122 of the manager client device 106(1). In another example, the remote client device 106(N) may receive the content 110(c) directly from the communication network 108 (e.g., without “going through” the manager client device 106(1)) but is authorized to do so when the client device 106(N) has a token that is assigned by the manager client device 106(1). A variety of other examples are also contemplated. Thus, the manager client device 106(1) may arbitrate which client devices 106(1)-106(N), including the manager client device 106(1) itself, are authorized to receive and/or output the content 110(c).

Although “manager/remote” architecture has been described to manage content consumption in the viewing system 104, a variety of other architectures are also contemplated without departing from the spirit and scope thereof. For example, the functionality of the “manager” may be distributed among each of the client devices 106(1)-106(N) such that arbitration of content consumption is performed by each of the devices. For instance, each of the client devices 106(1)-106(N) may implement similar techniques to manage token distribution (e.g., through execution of respective token modules 126(1)-126(N)) such that the devices “agree” based on common procedures as to which of the client devices 106(1)-106(N) is to be assigned a token and therefore is authorized to consume content. A variety of other examples are also contemplated.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 8. The features of the token bandwidth portioning techniques described below are platform-independent, meaning that the techniques may be implemented on a variety of commercial computing platforms having a variety of processors.

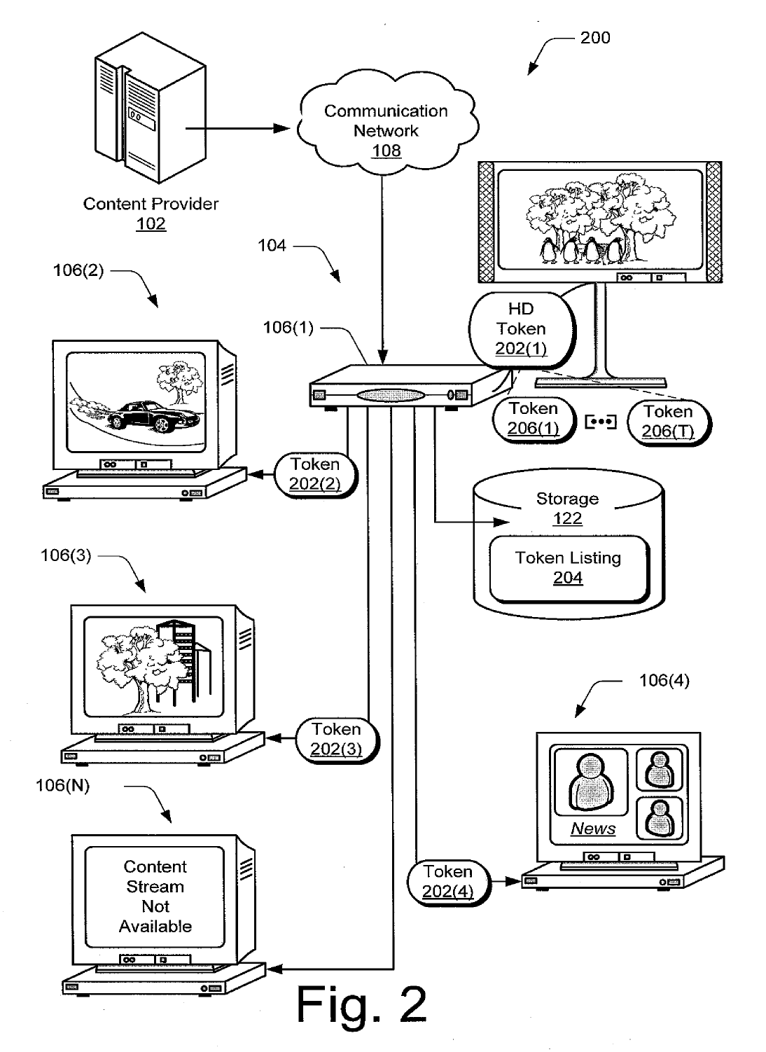

FIG. 2 illustrates an exemplary implementation of a system 200 showing allocation of content from the content provider 102 by the viewing system 104 of FIG. 1 in greater detail. The illustrated viewing system 104, as before, define a group that includes a plurality of client devices 106(1), 106(2), 106(3), 106(4) and 106(N). In this system, the manager client device 106(1) arbitrates control of four (4) streams of content (also referred to hereafter as “content streams”) from the content provider 102 via the communication network 108. For example, the content streams may be obtained by the remote clients 106(2)-106(N) through the manager client device 106(1). In another example, the content streams are managed by the manager client device 106(1), but the remote client devices 106(2)-106(N) receive the streams directly from the communication network 108. A variety of other examples are also contemplated.

Although the content streams are not shown specifically, the illustrated communication links illustrate various communication links which are configured to communicate the content streams. Additionally, the communication links are not intended to be interpreted as a one-way communication link, but rather may also represent two-way communication. A viewing selection from a first content stream is shown for viewing on display device at the manager client device 106(1). A second content stream is illustrated as directed from the manager client device 106(1) to the remote client device 106(2). Similarly, a third content stream is directed from the manager client device 106(1) to the remote client device 106(3) and a viewing selection from the third content stream is shown for viewing on a respective display device. Likewise, a fourth content stream is directed from the manager client device 106(1) to the remote client device 106(4) and a viewing selection from the fourth content stream is shown for viewing on a respective display device.

The available bandwidth for the viewing system 104, however, may not be able to accommodate as many content streams as there are client devices. As illustrated in FIG. 2, for instance, it is not unusual for a household to have five (5) or more televisions in various rooms and at various locations throughout the household. In this instance, the number of client devices exceeds the number of content streams allocated to the viewing system 104 from the content provider 102. For example, the viewing system 104 is depicted as including at least a fifth client device 106(N) of the viewing system 104. The corresponding display device of the client device 106(N) indicates that a content stream is not available, because the content streams allocated to the viewing system 104 (e.g., the four content streams) have already been directed to the other client devices 106(1)-106(4).

In the illustrated system 200 of FIG. 2, a technique is shown which utilizes tokens 202(1)-202(4) to arbitrate control of which of the client devices 106(1)-106(N) of the viewing system 104 are authorized to consume content 110(c) of FIG. 1 from the content provider 102. For example, each of the remote client devices 106(2)-106(N) may communicate with the manager client device 106(1) to receive a respective token 202(1)-202(4) that enables the respective remote client device 106(2)-106(N) to consume the content 110(c), such as render the content 110(c) for viewing. The manager client device 106(1), for instance, may maintain a token listing 204 in storage 122 which lists which tokens 202(1)-202(4) have been assigned to which respective client devices 106(1)-106(4). In the illustrated example, because client device 106(N) does not include one of the tokens 202(1)-202(N), the client device 106(N) is not authorized to consume content 110(c) from the content provider 102. A variety of techniques may be utilized to determine which clients receive tokens at a particular time, such as a priority listing, random number comparison (e.g., each client device generates a random number with the “higher” or “lower” number indicating who “wins” and is thus authorized to output content 110(c)), and so on.

The content streams allocated by the content provider 102 to the viewing system 104 may be configured in a variety of ways, such as a combination of high definition (HD) and/or standard definition (SD) content streams. For example, the viewing system 104 may receive one (1) high definition (HD) content stream and three (3) standard definition (SD) content streams depending upon available bandwidth to deliver the content streams over the communication network 108. As more bandwidth becomes available, the viewing system 104 may receive more high definition and/or standard definition content streams. Accordingly, the tokens 202(1)-202(4) may be configured to allocate these particular types of content streams. For example, token 202(1) is illustrated as an “HD token” and therefore a client device having that token 202(1) (e.g., the manager client device 106(1) in the illustration of FIG. 2) is authorized to receive and/or output the HD content stream. Because the other client devices 106(2)-106(4) do not have the HD token, however, these devices are restricted in this instance to receive and/or output a standard definition content stream.

The tokens may also be changeable to “free” bandwidth that is not being utilized. For example, client device 106(1) as previously described is assigned the HD token 202(1) which permits use of an amount of bandwidth sufficient to consume HD content. The client device 106(1), however, may be using the HD token 202(1) to consume non-HD content, such as by consuming SD content. Therefore, in order to permit client device 106(N) to also consume content, the HD token 202(1) may be “changed” into a plurality of tokens 206(1)-206(T) that permit the client devices that are assigned the tokens to consume content having lesser bandwidth than that corresponding to the HD token 202(1).

For instance, two SD streams may consume a similar amount of bandwidth as a single HD stream. Therefore the HD token 202(1) may be changed into two SD tokens 206(1)-206(T) which are assigned, respectively, to the manager client device 106(1) and the remote client device 106(N). Thus, both client devices 106(1), 106(N) are able to consume content without exceeding the amount of bandwidth allocated to the viewing system 104 as a whole. Further discussion of changeability of tokens may be found in relation to FIG. 5.

The system 200 may also provide for the purchase of additional tokens by the viewing system 104 to consume content. For example, when bandwidth allocated to the viewing system 104 by the content provider 102 is to be exceeded, such as to consume additional content 110(c), additional tokens may be purchased to permit consumption of the additional content 110(c). Remote client device 106(N), for instance, in addition to displaying an indication that content is not available may display another indication which notifies a user of the remote client device 106(N) that the requested content may be consumed for an additional fee. Thus, initial bandwidth allocated to the viewing system 104 may be expanded to enable the client device 106(N) to consume content in addition to the allocated content consumption of the other client devices 106(1)-106(N). The additional token may be allocated in a variety of ways, such as to consume particular content, a particular stream of content for a particular amount of time, and so on. Further discussion of content consumption and purchasable tokens may be found in relation to FIGS. 6-7.

The manager may also be configured to provide additional functionality to the viewing system 104. For example, the manager client device 106(1) may be configured to control content recordation performed by the viewing system 104, whether the recordation occurs locally at the manager, distributed across the viewing system 104, remotely as a network digital video recorder (NDVR), and so on. This recordation may also be managed through the use of tokens, since a portion of the bandwidth from the content provider 102 is consumed by recording the content in storage 122. In another example, the manager client device 106(1) may act as a “playback service” such that the remote client devices 106(2)-106(N) may request content from the manager client device 106(1) that does not use tokens for consumption, e.g., to stream content 124(o) from storage 122. In a further example, the manager client device 106(1) may manage consumption of content using tokens that have already been assigned, e.g., to show a notification to the remote devices that, if not answered, causes the respective token to be removed for use by the manager client device 106(1) to record content. A variety of other examples are also contemplated, further discussion of which may be found in relation to the following exemplary procedures.

Exemplary Procedures

The following discussion describes token bandwidth portioning techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders showing for performing the operations by the respective blocks. In portions of the following discussion, reference will be made to the environment 100 of FIG. 1 and the system 200 of FIG. 2.

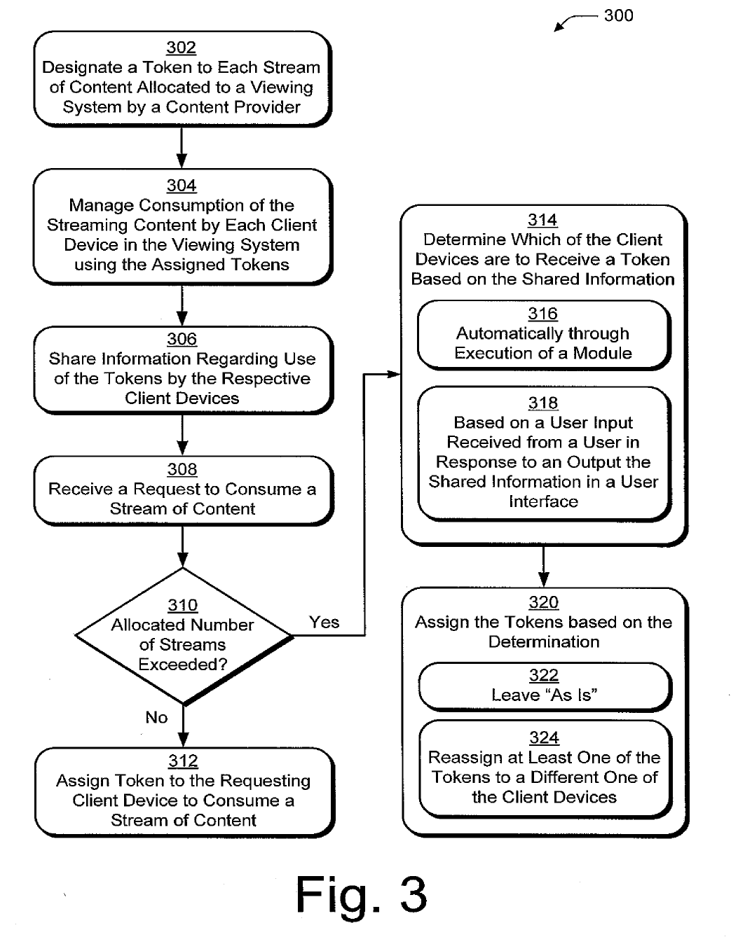

FIG. 3 depicts a procedure 300 in an exemplary implementation in which portions of bandwidth provided by a content provider are assigned tokens to manage consumption of the content in a viewing system. A token is designated to each steam of content allocated to a viewing system by a content provider (block 302). For example, the content provider 102, through execution of the content manager module 114, may provide four streams of content 110(c) to each location serviced by the content provider 102, such as the household depicted in FIG. 1. The viewing system 104 located at the household may be configured accordingly and therefore designate a token (e.g., tokens 202(1)-202(4)) to each stream of content.

For instance, the viewing system 104 may be configured for use with the particular content provider 102 and therefore be configured by a manufacturer of the viewing system (and more particularly the client devices 106(1)-106(N) which form the viewing system) to consume that number of content streams. In another instance, the tokens may be assigned dynamically by the viewing system 104. The manager client device 106(1), for example, may determine how many content streams are available to the viewing system 104 (e.g., by communicating with the content provider 102, analyzing content 110(c) that is streamed over the communication network 108, and so on) and designate an appropriate number of tokens. A variety of other instances are also contemplated.

Consumption of the streaming content by each client device in the viewing system is managed using the assigned tokens (block 304). For example, information regarding use of the tokens by the respective client devices may be shared (block 306). Client devices 106(2)-106(N), for instance, may communicate information to client device 106(1) (i.e., the manager client device) which describes what content is being consumed using the assigned token. The client device 106(1) may then update the token listing 204 to reflect this information.

Therefore, when a request is received to consume a stream of content (block 308), a determination is made as to whether the allocated number of streams has been exceeded (decision block 310). For example, the client device 106(1), through examination of the token listing 204, may determine whether each token (e.g., tokens 202(1)-202(4)) has been assigned. If not (“no” from decision block 310), an unassigned token is assigned to the requesting client device to consume a stream of content (block 312). Thus, in this example when a token is available it may be quickly assigned to the requesting client device.

When the allocated number of streams has been exceeded (“yes” from decision block 310), however, a determination is made as to which of the client devices are to receive a token based on the shared information (block 314). This determination may be performed in a variety of ways. For example, the determination may be performed automatically through execution of a module (block 316) based on a variety of considerations, such as based on a scheduling priority, whether one or more of the client devices which is assigned a token is “idle”, and so on. Thus, in this example, the user is not involved in the determination.

In another example, however, the determination is made based on a user input received form a user in response to an output of the shared information in a user interface (block 318). For instance, the shared information which describes which content is being consumed by which client devices 106(1)-106(N) in the viewing system 104 may be output in a user interface. The user, when viewing this information, may then determine which client devices 106(1)-106(N) should consume the content. The manager client device 106(1), for instance, may be assigned two tokens, one to render a television program (e.g., a sitcom) and another one to store another television program (e.g., a sporting event) in storage 122 as content 124(o). A user of the remote client device 106(N) may then decide to override storage of the sporting event in order to consume yet another television program, e.g., high-definition audio. Therefore, the user may provide an input which indicates that recordation of the sporting event is to stop and the token is to be assigned to the remote client device 106(N) to output the high-definition audio.

The tokens are then assigned based on the determination (block 320). For example, the user in the previous example may choose to forgo listening to the high-definition audio, and instead view, the sporting event. Therefore, the spoiling event may be streamed to the remote client device 106(N) from the manager client device 106(1) without assigning the token to the remote client device 106(N). This may be performed because the viewing system 104 as a whole is still not consuming more than the allocated number of content streams from the content provider, and is forwarding the streams between devices within the viewing system 104, e.g., streaming content from storage 122 of the manager client device 106(1) to the remote client device 106(N). Thus, even though the determination is to leave the tokens assigned “as is” (block 322), the viewing system 104 may further manage content consumption within the viewing system 104.

In another example, at least one of the tokens may be reassigned to a different one of the client devices (block 324). For instance, the user, when viewing the shared information in the user interface, may determine that another one of the client devices may be overridden, the execution of the module (e.g., block 316) may determine that the requesting client device has priority, and so on. Therefore, a token that is currently assigned to another client device may be assigned to the requesting client device. A variety of other examples are also contemplated.

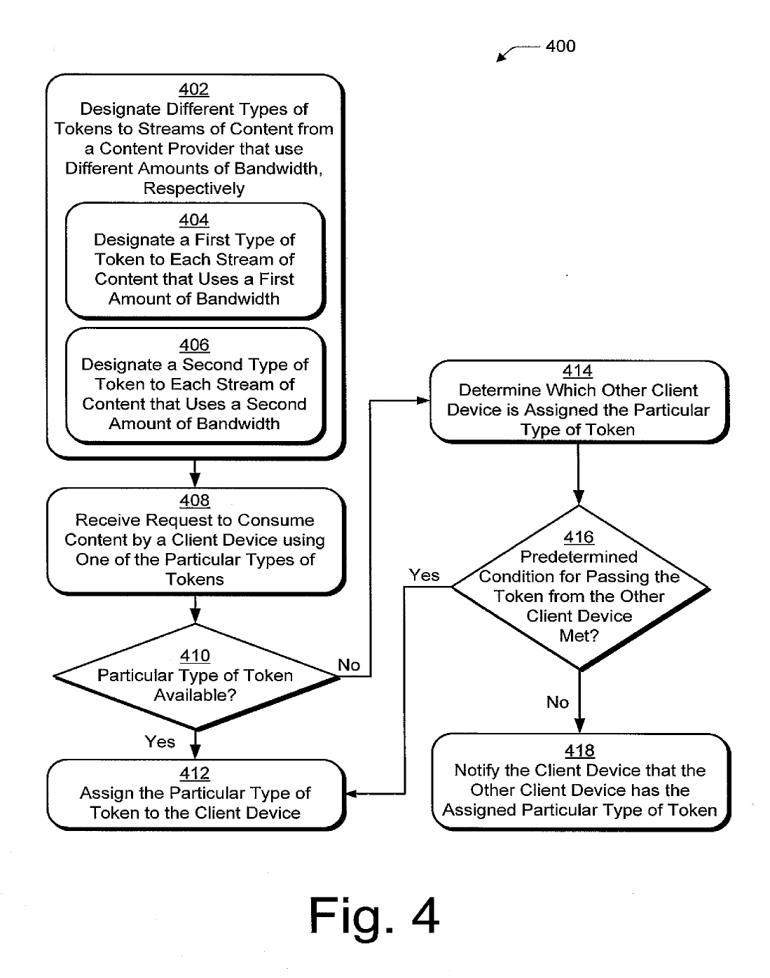

FIG. 4 depicts a procedure 400 in an exemplary implementation in which different types of tokens in a viewing system are managed to consume content. Different types of tokens are designated to streams of content, from a content provider, that use different amounts of bandwidth, respectively (block 402). For example, the content provider 102 may provide four streams of content to each of a plurality of locations serviced by the content provider 102, such as individual households. Three of the streams of content may be configured for standard definition (SD) content, while one of the streams of content is configured for high-definition (HD) content, an example of which is shown in FIG. 2. Therefore, a first type of token may be designated to each stream of content that uses a first amount of bandwidth (block 404) and a second type of token is designated to each stream of content that uses a second amount of bandwidth (block 406). Continuing with the previous example, an SD token may be assigned to each SD stream and an HID token may be assigned to each HD stream such that the viewing system 104 includes one HD token (e.g., HD token 202(1)) and three SD tokens (e.g., tokens 202(2)-202(4)). As previously described in relation to FIG. 3, the designating may be performed in a variety of ways, such as by pre-configuring the client devices 106(1)-106(N), dynamic determination, and so forth.

A request is received to consume content from a client device by using one of the particular types of tokens (block 408). For example, client device 106(N) may form the request to consume HD content. A determination is then made as to whether the particular type of token is available (decision block 410), such as through examination of the token listing 204 by the manager client device 106(1). If so (“yes” from decision block 410), the particular type of token is assigned to the client device (block 412).

When the particular type of token is not available (“no” from decision block 410), a determination is made as to which other client device is assigned the particular type of token (block 414). For example, the manager client device 106(1) may examine the token listing 204 to determine which of the client devices 106(1)-106(N) was previously assigned use of the HD token 202(1), which in this case is the manager client device 106(1) itself.

A determination is then made as to whether a predetermination condition has been met for passing the token from the other client device (decision block 416). A variety of different predetermined conditions may be applied. For example, the predetermined condition may be whether the client device that is assigned the token is idle as based on whether an input has been received from a user within a predetermined amount of time. In another example, the predetermined condition is whether the client device having the assigned token has a lower priority than the client device requesting the token. A variety of other examples are also contemplated.

When the predetermined condition has been met (“yes” from decision block 416), the particular type of token is assigned to the client device (block 412). Thus in this example, the token is passed from the client device to the requesting client device. However, when the predetermined condition has not been met (“no” from decision block 416), the client device is notified that the other client device has the assigned particular type of token (block 418). Therefore, in this example the user is not notified unless the particular type of token is not available to the client device as determined by the manager client device. Once notified, a user of the requesting client device may then take action to obtain the token, such as by shutting down the other client device having the assigned token, talking to a user of the other client device to watch a different type of content, and so on. Although notification to the user after the determination of the predetermined condition has been described, it should be apparent that a wide variety of other examples are also contemplated.

FIG. 5 depicts a procedure 500 in an exemplary implementation in which a token type is changed for a first client when a second client attempts to consume content that would cause bandwidth allocated to a viewing system to be exceeded. Different types of tokens are designated to portion bandwidth allocated to a viewing system by a content provider (block 502). For example, a first type of token is designated that permits use of a first amount of bandwidth (block 504) and a second type of token is designated that permits use of a second amount of bandwidth (block 506). In this example, the second amount of bandwidth is less than the first amount of bandwidth. For instance, the first type of token may permit consumption of HD and SD content and the second type of token may permit consumption of SD content. A variety of other instances are also contemplated.

The first type of token is assigned to a first client (block 508), such as by assigning the HD token 202(1) to client device 106(1). A second client then attempts to consume content that would cause the viewing system to exceed the allocated bandwidth (block 510). For example, client device 106(N) may be turned on by a user to consume content, such as to display a television program. However, each of the other tokens 202(1)-202(4) may already be assigned to other respective clients 106(1)-106(4), which as described and illustrated in the example of FIG. 2 is three SD tokens 202(2)-202(4) and one HD token 202(1). Further, these tokens represent the maximum amount of bandwidth allocated to the viewing system 104. Therefore, if the client device 106(N) was to consume content, that content consumption may exceed the bandwidth allocated by the content provider 102.

The first type of token assigned to the first client device is changed to the second type of token (block 512). As previously described, client device 106(1) is assigned the HD token 202(1). However, in this instance client device 106(1) is not using the HD token 202(1) to consume HD content, but rather uses the HD token 202(1) to consume content that uses less bandwidth, such as SD content. Therefore, additional bandwidth is available to the viewing system 104 that is not being used by the client device 106(1). In an implementation, because changing the token would not affect the client's 106(1) ability to consume desired content, the type of the token is changed to a token that uses a lesser amount of bandwidth, such as an SD token. Therefore, the second client device (e.g., client device 106(N)) may be assigned a token (block 514), such as an SD token, to consume content without causing the viewing system 104 to exceed the amount of bandwidth allocated for use by the plurality of client devices 106(1)-106(N) as a whole at any one time. Thus, the fist client device and the second client device may consume content simultaneously (block 516). A variety of other examples are also contemplated, such as to assign a token to the second client device that uses less bandwidth than the token assigned to the first client device, e.g., assign an enhanced-definition token to client device 106(1) and an SD token to client device 106(N).

FIG. 6 depicts a procedure 600 in an exemplary implementation in which purchasable token bandwidth portioning techniques are described. During the discussion of FIG. 6, reference will also be made to FIG. 7, which illustrates a user interface 700 in an exemplary implementation which may be employed in the procedure of FIG. 6.

Tokens are designated to portion bandwidth allocated to a group of client devices by a content provider to stream content (block 602). For example, content provider 102 may allocate an initial amount of bandwidth, such as one HD stream of content and three SD streams of content as shown in FIG. 2. Therefore, tokens 202(1)-202(4) may be designated to each stream of bandwidth to control content consumption within the group (e.g., the viewing system 104) as previously described.

Content consumption is attempted by at least one of the client devices that would cause the group to exceed the allocated bandwidth (block 604). For example, client device 106(N) may be “powered on” and attempt to consume content 110(c) from the content provider 102. However, each of the tokens (e.g., tokens 202(1)-202(4)) which were designated to portion the bandwidth allocated by the content provider may already be assigned to other client devices, e.g., client devices 106(1)-106(4). Therefore, consumption of content by the client device 106(N) would exceed the amount of bandwidth allocated to the group, e.g., the viewing system 104.

An additional token is therefore purchased (block 606) to permit the client device 106(N) to consume content. FIG. 7, for instance, illustrates an exemplary user interface 700 as being output by the client device 106(N) which indicates that content consumption by the at least one client device (e.g., client device 106(N)) would cause bandwidth allocated to the group to be exceeded (block 608). The user interface 700 in this instance is illustrated as included text 702 stating that the “content stream is not available”. The user interface 700 also includes text 704 which states that the user may “select ‘purchase’ to purchase additional bandwidth to consume the content stream” and a portion 706 that is selectable by the user to purchase the additional bandwidth. In another example, purchase of a token may be performed automatically, such as through a preauthorization to purchase tokens provided by the user, such as over “X” period of time the module is authorized to spend “Y”, amount of dollars to purchase tokens. In another example, content may be conditionally recorded, but in order to play it back, a token is retroactively purchased. A variety of other examples are also contemplated.

The client device 106(N) may therefore receive an input from the user authorizing purchase of an additional token (block 610) by selecting the portion 706 in the user interface 700. A request is then formed for communication to the content provider (block 612) and is received by the content provider to purchase bandwidth in addition to bandwidth already allocated to the group (block 614). For instance, the request may include billing information which may be used by the content provider 102 to process the request, such as user identification (ID), account number, and so on.

After the request is processed, a response is formed for communication to the at least one client device that indicates whether the additional bandwidth has been purchased (block 616). The response may be formed in a variety of ways. For example, the response may be a token that permits consumption of a particular content item (e.g., a VOD movie), consumption of a content stream for a designated amount of time (e.g., to permit the client device 106(N) to consume a content stream from different television channels), and so on. Therefore, the content is consumable at the at least one client device (block 616), e.g., client device 106(N), without interrupting content consumption of other client devices, e.g., client device 106(1)-106(4). A variety of other examples are also contemplated, such as for purchase of a temporary token for a limited period, a permanent token that permits consumption of the additional amount of content based on a subscription, and so on.

Exemplary Systems

FIG. 8 illustrates an exemplary implementation 800 of a client device 106(n) (which may or may not correspond to one or more of the client devices 106(1)-106(N) of FIG. 2) in greater detail. The client device 106(n) may be implemented as any form of a computing, electronic, and/or television-based client device.

Client device 106(n), as illustrated in FIG. 8, includes one or more media content inputs 802 which may include Internet Protocol (IP) inputs over which streams of media content are received via an IP-based network. Client device 106(n) further includes communication interface(s) 804 which can be implemented as any one or more of a serial and/or parallel interface, a wireless interface, any type of network interface, a modem, and as any other type of communication interface. A wireless interface enables client device 106(n) to receive control input commands 806 and other information from an input device, such as from remote control device 808, PDA (personal digital assistant) 810, cellular phone 812, or from another infrared (TR), 802.11, Bluetooth, or similar radio frequency (RF) input device.

A network interface provides a connection between the client device 106(n) and a communication network by which other electronic and computing devices can communicate data with device 106(n). Similarly, a serial and/or parallel interface provides for data communication directly between client device 106(n) and the other electronic or computing devices. A modem facilitates client device 106(n) communication with other electronic and computing devices via a conventional telephone line, a digital subscriber line (DSL) connection, cable, and/or other type of connection.

Client device 106(n) also includes one or more processors 814 (e.g., any of microprocessors, controllers, and the like) which process various computer executable instructions to control the operation of client device 106(n), such as to communicate with other electronic and computing devices. Client device 106(n) can be implemented with computer-readable media 816, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like. It should be apparent that although a single computer-readable media 816 is illustrated, the computer readable media 816 may be representative of multiple types and combinations of computer-readable media.

Computer-readable media 816 provides data storage mechanisms to store various information and/or data such as software applications and any other types of information and data related to operational aspects of client device 106(n). For example, an operating system 818 and/or other application modules 820 can be maintained as software applications with the computer-readable media 816 and executed on the processor(s) 814.

For example, one or more of the other application modules 820 can be implemented as a program guide application that processes program guide data and generates program guides for display. The program guides enable a viewer to navigate through an onscreen display and locate broadcast programs, recorded programs, video-on-demand (VOD), movies, interactive game selections, network-based applications, and other media access information or content of interest to the viewer. Likewise, the computer-readable media 816 may also store the token module 822 and/or token listing 824 that is used to manage tokens (and therefore content consumption) as previously described in relation to FIGS. 1-4. The client device 106(n) may also include a DVR system 826 with the content module 828 (which may or may not correspond to the content modules 116(1)-116(N) of FIG. 1) and recording media 830 (which may or may not correspond to the storage 122 of FIG. 1) to maintain recorded content 832.

The client device 106(n), as illustrated, also includes an audio and/or video input/output 834. The audio/video input/output 834 may be utilized for a variety of purposes, such as to provide audio and video to an audio rendering and/or display system 836 and/or to other devices that process, display, and/or otherwise render audio, video, and image data. Video signals and audio signals, for instance, may be communicated from client device 106(n) to a television 838 (or to other types of display devices) via an RE (radio frequency) link, S-video link, composite video link, component video link, analog audio connection, or one or more other such communication links.

FIG. 9 illustrates a system 900 in an exemplary implementation in which the content provider 102 is shown in greater detail. System 900 facilitates the distribution of program content, program guide data, and advertising content to multiple viewers and to multiple viewing systems. System 900 includes the content provider 102 and the plurality of client devices 106(1)-106(N), each being configured for communication via an IP-based network 108. Each of the client devices 106(1)-106(N), for instance, may receive one or more content streams from the content provider 102 and then arbitrate stream allocation to distribute the content streams (e.g., one to each) to one or more other remote client devices in the viewing system 104.

The communication network 108 may be implemented in a wide variety of ways, such as a wide area network (e.g., the Internet), an intranet, a Digital Subscriber Line (DSL) network infrastructure, a point-to-point coupling infrastructure, and so on. Additionally, the communication network 108 can be implemented using any type of network topology and any network communication protocol, and can be represented or otherwise implemented as a combination of two or more networks. A digital network can include various hardwired and/or wireless links 902(1)-902(N), routers, gateways, and so on to facilitate communication between content provider 7102 and the client devices 106(1)-106(N). The client devices 106(1)-106(N) receive content (e.g., television programs, program guide data, advertising content, closed captions data, and the like) from content server(s) 904 of the content provider 902 via the communication network 108.

System 900 may also include a variety of servers to provide functionality, such as to obtain and provide specific types of content. For example, the illustrated system 900 includes a media server 906 that receives program content from a content source 908, program guide data from a program guide source 910, and advertising content from an advertisement source 912. In an embodiment, the media server 906 represents an acquisition server that receives the audio and video program content from content source 908, an EPG server that receives the program guide data from program guide source 910, and/or an advertising management server that receives the advertising content from the advertisement source 912.

The content source 908, the program guide source 910, and the advertisement source 912 control distribution of the program content, the program guide data, and the advertising content to the media server 906 and/or to other servers. The program content, program guide data, and advertising content is distributed via various transmission media 914, such as satellite transmission, radio frequency transmission, cable transmission, and/or via any number of other wired or wireless transmission media. In this example, media server 906 is shown as an independent component of system 900 that communicates the program content, program guide data, and advertising content to content provider 102. In an alternate implementation, media server 906 can be implemented as a component of content provider 102.

Content provider 102 in the system 900 of FIG. 9 is representative of a headend service in a television-based content distribution system, for example, that provides the program content, program guide data, and advertising content to multiple subscribers, e.g., the client devices 106(1)-106(N). The content provider 102 may be implemented in a variety of ways, such as a satellite operator, a network television operator, a cable operator, and the like to control distribution of program and advertising content, such as movies, television programs, commercials, music, and other audio, video, and/or image content to the client devices 106(1)-106(N).

Content provider 102 includes various components to facilitate content processing and distribution, such as a subscriber manager 916, a device monitor 918, and the content server 904. The subscriber manager 916 manages subscriber data, and the device monitor 918 monitors the client devices 106(1)-106(N) (e.g., and the subscribers), and maintains monitored client state information.

Although the various managers, servers, and monitors of content provider 102 (to include the media server 906 in an embodiment) are illustrated and described as distributed, independent components of content provider 102, any one or more of the managers, servers, and monitors can be implemented together as a multi-functional component of content provider 102.

The client devices 106(1)-106(N), as previously described, may be implemented in any number of embodiments, such as a set-top box, a digital video recorder (DVR) and playback system, a personal video recorder (PVR), an appliance device, a gaming system, and as any other type of client device that may be implemented in a television-based entertainment and information system. In an alternate embodiment, client device 106(N) is implemented via a computing device. Additionally, any of the client devices 106(1)-106(N) can implement features and embodiments of token bandwidth portioning as described herein.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
designating tokens to portion bandwidth allocated to a group of client devices by a content provider to stream content; and
when at least one said client device attempts content consumption that would cause the group to exceed the allocated amount of bandwidth, purchasing an additional token.

2. A method as described in claim 1, wherein the additional token purchased corresponds to an amount of bandwidth that is caused by content consumption of the at least one said client device which exceeds the amount of bandwidth allocated to the viewing system by the content provider.

3. A method as described in claim 1, wherein:
each said token corresponds to a particular stream of content from the content provider; and
the additional token permits consumption of another stream of content from the content provider.

4. A method as described in claim 1, wherein:
the additional token is purchased by the at least one said client device from the content provider over a network; and
the purchasing is performed automatically and without user intervention when the at least one said client device attempts content consumption that would cause the group to exceed the allocated amount of bandwidth.

5. A method as described in claim 1, wherein the purchasing includes:
outputting a user interface which indicates to a user that content consumption by the at least one said client device would cause bandwidth allocated to the group to be exceeded; and
receiving an input from the user authorizing purchase of the additional token.

6. A method as described in claim 1, further comprising consuming the content by the at least one said client device using the purchased token.

7. A method as described in claim 6, wherein the consuming includes rendering the content or storing the content in a computer-readable medium.

8. A method as described in claim 1, wherein the designating includes designating different types of tokens, in which, a first said type of token permits use of a first amount of bandwidth and a second said type of token permits use of a second amount of bandwidth that is less than the first amount of bandwidth.

9. A method as described in claim 8, wherein the first said type permits consumption of high-definition (HD) content.

10. A method comprising:
receiving a request to purchase bandwidth in addition to bandwidth already allocated to a group of client devices by a content provider to consume content streamed to the group by the content provider; and
forming a response to the request for communication to at least one said client device that indicates whether the additional bandwidth has been purchased.

11. A method as described in claim 10, wherein the response includes a stream of content from the content provider that uses bandwidth in addition to the bandwidth which was already allocated to the group.

12. A method as described in claim 10, wherein the request includes billing information and further comprising processing the billing information by the content provider.

13. A method as described in claim 10, wherein:
the content includes television programs; and
the content provider includes a head end that performs the receiving and the forming.

14. A method as described in claim 10, wherein:
the group is situated at one of a plurality of locations serviced by the content provider;
each said location includes a respective said group; and
at least two said groups have matching allocated amounts of bandwidth from the content provider.

15. One or more computer-readable media comprising computer executable instructions that are executable by a client device included in a group having a plurality of said client devices that are configured to consume content streamed from a content provider over a network, wherein the computer-executable instructions are executable to output a user interface which indicates that additional bandwidth is available for purchase when it is determined that bandwidth allocated by the content provider to the group of client devices will be exceeded.

16. One or more computer-readable media as described in claim 15, wherein the bandwidth is allocated for use in the system through use of tokens.

17. One or more computer-readable media as described in claim 15, wherein a first type of token permits use of a first amount of bandwidth and a second said type of token permits use of a second amount of bandwidth.

18. One or more computer-readable media as described in claim 15, wherein the user interface further includes an indication of current consumption of content by one or more said client devices.

19. One or more computer-readable media as described in claim 18, wherein the user interface further includes:
an indication of current consumption of content by one or more said client devices; and
a portion that is selectable to purchase the additional bandwidth.

20. One or more computer-readable media as described in claim 19, wherein the portion, when selected, causes a request to be formed that includes billing information to purchase the additional bandwidth.
